(19) United States
(12) Patent Application Publication
(10) Pub. No.: US 2015/0062919 A1
(43) Pub. Date: Mar. 5, 2015

(54) OPTICAL LENS POSITIONING SYSTEM AND METHOD

(71) Applicant: Ford Global Technologies, LLC, Dearborn, MI (US)

(72) Inventors: John Teodecki, Grosse Pointe Park, MI (US); Gary Edward Henige, Northville, MI (US); Stephen Kenneth Helwig, Farmington Hills, MI (US); Sleiman N. Abdelnour, Macomb, MI (US); Kevin William Kiedaisch, Brownstown, MI (US)

(73) Assignee: Ford Global Technologies, LLC, Dearborn, MI (US)

(21) Appl. No.: 14/018,966

(22) Filed: Sep. 5, 2013

(51) Int. Cl. F21V 5/04; F21K 99/00

(52) U.S. Cl. CPC F21V 5/04; F21K 9/50
USPC 362/311.02; 362/311.01; 29/464

(57) ABSTRACT

An optical lens positioning system and method are provided that includes an illumination source, an optical lens, and a retaining mechanism having a plurality of alignment members that are displaceable in a first plane and resist being displaced in a second plane that is orthogonal to the first plane, wherein the plurality of alignment members are coupled to the optical lens to retain the optical lens proximate to the illumination source.

### FIELD OF THE INVENTION

The present invention generally relates to illumination systems, and more specifically to illumination systems in which an optical lens is positioned relative to an illumination source.

### BACKGROUND OF THE INVENTION

Illumination systems are used in a variety of applications. One shortcoming arising in current illumination systems includes the occurrence of tolerance stack up when an optical lens is positioned relative to an illumination source in order to collect and project light. As a result of tolerance stack up, the efficiency and precision of the illumination system may be adversely affected, which generally manifests itself as less than optimal light output from the optical lens. Thus, there is a need for an optical lens positioning system having minimal tolerance stack up and optimal light output capabilities.

### SUMMARY OF THE INVENTION

According to one aspect of the present invention, an optical lens positioning system is provided that includes an illumination source, an optical lens, and a retaining mechanism having a plurality of alignment members that are displaceable in a first plane and resist being displaced in a second plane that is orthogonal to the first plane, wherein the plurality of alignment members are coupled to the optical lens to retain the optical lens proximate to the illumination source.

According to another aspect of the present invention, an optical lens positioning system is provided and includes a retaining mechanism operably coupled to an illumination source and having a first and a second alignment member displaceable in nonplanar planes. An optical lens is disposed between the first and second alignment members, wherein the first and second alignment members are configured to retain the optical lens in a fixed position proximate the illumination source.

According to another aspect of the present invention, an optical lens positioning method is provided and includes the steps of providing a retaining mechanism having a plurality of alignment members, abutting the plurality of alignment members against a periphery of an optical lens, adjusting the position of the optical lens, which causes the plurality of alignment members to be displaced, and using the plurality of alignment members to retain the optical lens in a fixed position proximate an illumination source.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a top perspective view of one embodiment of an optical lens positioning system that includes a retaining mechanism and an optical lens;

FIG. 2 is a top perspective exploded view of the optical lens positioning system of FIG. 1;

FIG. 3 is a top perspective view of one embodiment of an optical lens positioning system of FIG. 1, wherein the retaining mechanism is shown retaining the optical lens in a fixed position proximate an illumination source;

FIG. 4 is a bottom perspective view of the optical lens positioning system of FIG. 3; and

FIG. 5 is a top view of the optical lens positioning system of FIG. 3.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

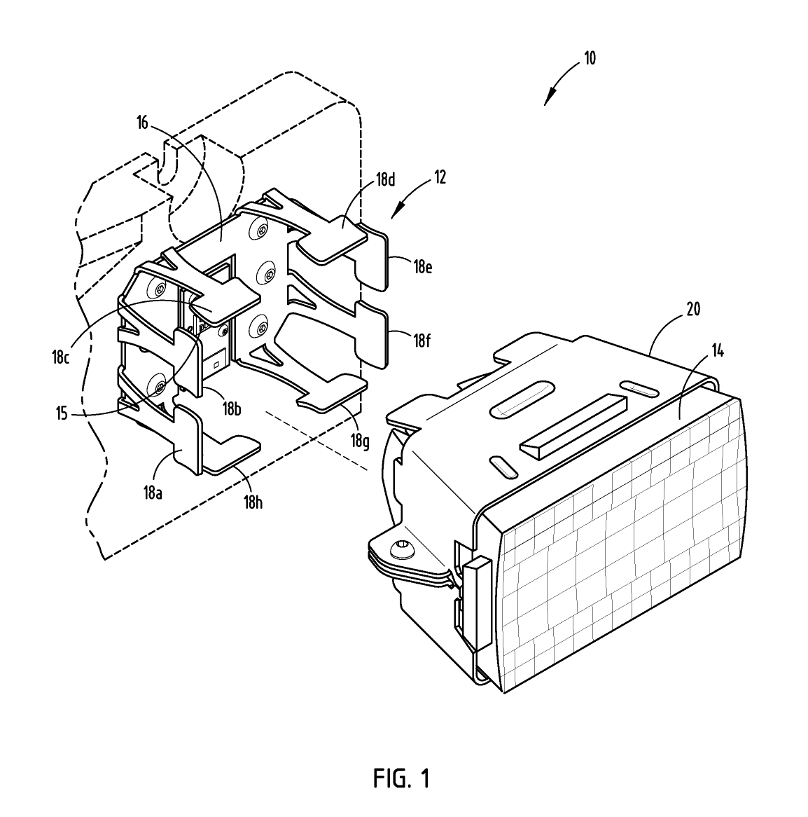

Referring to FIG. 1, reference numeral 10 generally designates an optical lens positioning system having a retaining mechanism 12 for retaining an optical lens 14 proximate an illumination source 15. The retaining mechanism 12 includes a base 16 and at least one alignment member that is shown in one embodiment having eight alignment members 18a-18h coupled to the base 16 and extending therefrom. The alignment members 18a-18h are coupled to the periphery of the optical lens 14, which may be a stand alone or housed in a lens holder 20. While eight alignment members 18a-18h are shown and described herein, it should be appreciated that other numbers, shapes, and/or sizes of alignment members may be employed according to other embodiments.

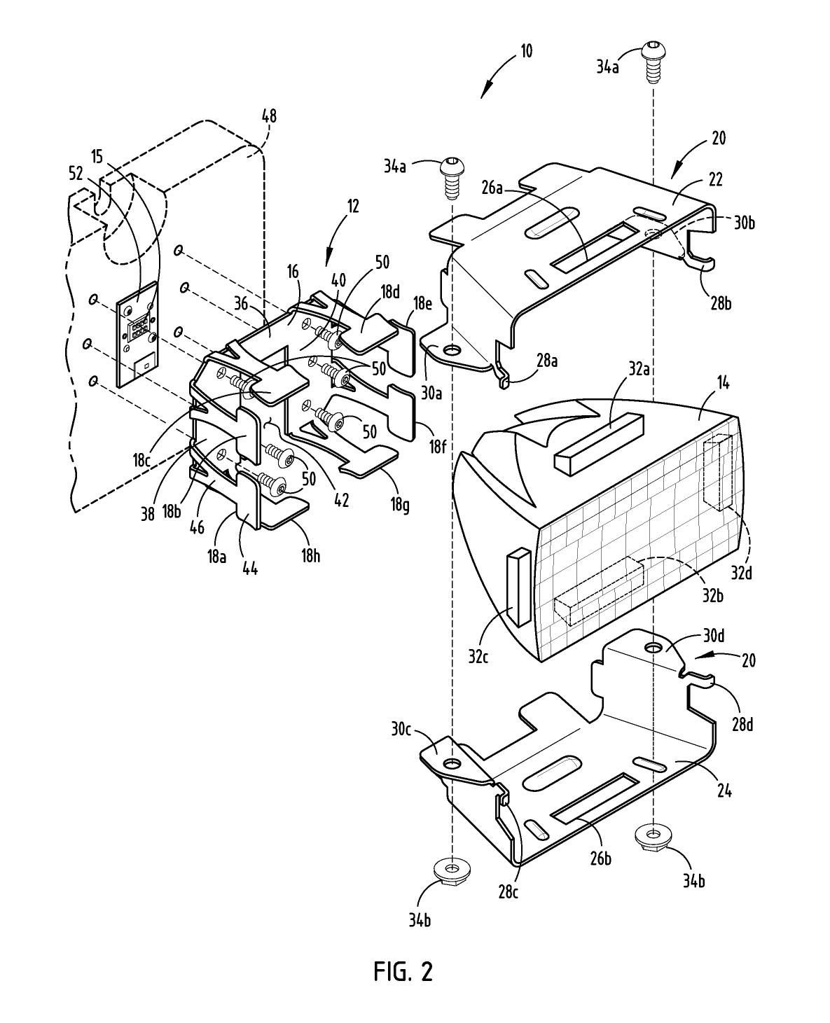

Referring to FIG. 2, one embodiment of the optical lens 14 and the lens holder 20 is shown. In the illustrated embodiment, the lens holder 20 includes a first section 22 configured to be stacked on top of a second section 24 for holding the optical lens 14 therebetween. The first section 22 includes an aperture 26a, a pair of oppositely disposed tabs 28a, 28b, and a pair of oppositely disposed flanges 30a, 30b. Similarly, the second section includes an aperture 26b, a pair of oppositely disposed tabs 28c, 28d, and a pair of oppositely disposed flanges 30c, 30d. In the illustrated embodiment, aperture 26a is aligned with aperture 26b, tabs 28a and 28b are aligned with tabs 28c and 28d, respectively, and flanges 30a and 30b are aligned with flanges 30c and 30d, respectively.

The optical lens 14 includes projections 32a-32d, wherein projection 32a is formed opposite to projection 32b and projection 32c is formed opposite to projection 32d. To assemble the optical lens 14 inside the lens holder 20, the optical lens 14 is sandwiched between the first and second sections 22, 24 such that aperture 26a receives projection 32a and aperture 26b receives projection 32b. In this arrangement, tabs 28a and 28c abut against projection 32c and tabs 28b and 28d abut against projection 32d. To prevent disassembly of the lens holder 20, flange 30a is adapted for connection with flange 30c and flange 30b is adapted for connection with flange 30d via mechanical fasteners 34a and 34b. In addition, or alternatively, adhesives and/or other suitable bonding methods may be used for connecting flanges 30a and 30b to 30c and 30d, respectively.

The optical lens 14 may be a variety of lens types and take on a variety of configurations.

As such, the lens holder 20 may be constructed in a variety of shapes to accommodate different optical lens configurations. For instance, the lens holder 20 may contour the optical lens 14 or may be of a different shape than the optical lens 14. In the illustrated embodiment, the lens holder 20 has a tapered configuration and the optical lens 14 includes a collimating lens, which focuses collected light as a light beam and may be used in various automotive lighting assemblies such as, but not limited to, head lamps, fog lamps, backup lamps, supplemental lamps (i.e. trailer hitch lamps), daytime lamps, and/or turn signal lamps. Thus, one contemplated use of the optical lens positioning system 10 disclosed herein includes automotive lighting applications. However, it is to be understood that the optical lens positioning system 10 is also readily adaptable to other lighting applications without departing from the teachings provided herein.

Referring again to FIG. 2, one embodiment of the retaining mechanism 12 is shown. In the illustrated embodiment, the base 16 of the retaining mechanism 12 is planar and includes an intermediate portion 36 connecting a first and second linear portion 38, 40 to form a space 42 therebetween. The alignment members 18a-18h are coupled to the periphery of the base 16 and are configured to be displaceable to enable the optical lens 14 to be retained in a variety of positions. When not retaining the optical lens 14, it is contemplated that the alignment members 18a-18h may be disposed orthogonally or angled relative to the base 16. The alignment members 18a-18h each include a distal connecting portion 44 and a bipedal portion 46, which are shown on alignment member 18a. The bipedal portion 46 is coupled to the base 16 and widens as it extends from the connecting portion 44 towards the base 16. In addition, it is contemplated that the connecting portion 44 and bipedal portion 46 may each have linear and/or non-linear configurations and may be coplanar and/or nonplanar with respect to one another.

In the illustrated embodiment, the alignment members 18a-18h are cantilevered to the base 16 and are constructed from a flexible material (i.e. metal or plastic) such that alignment members 18a, 18b, 18e, and 18f are each displaceable in a corresponding first plane and alignment members 18c, 18d, 18g, and 18h are each displaceable in a corresponding second plane, wherein displacement of alignment members 18a-18h occurs via a flexing motion. With respect to the illustrated embodiment as oriented in FIG. 2, the first plane includes horizontal (i.e. sideways) flexing of corresponding alignment members 18a, 18b, 18e, and 18f relative to the base 16 and the second plane includes vertical (i.e. upwards/downwards) flexing of corresponding alignment members 18c, 18d, 18g, and 18h relative to the base 16. In this configuration, the first plane corresponding to alignment members 18a, 18b, 18e, and/or 18f is nonplanar with the second plane corresponding to alignment members 18c, 18d, 18g, and/or 18h. More specifically, and with respect to the illustrated embodiment, the first plane corresponding to alignment members 18a, 18b, 18e, and/or 18f is orthogonal to the second plane corresponding to alignment members 18c, 18d, 18g, and/or 18h. Furthermore, due to the coupling of alignment members 18a-18h to the base 16, the alignment members 18a-18h will tend to resist being displaced in a plane that is orthogonal to their corresponding planes. With respect to the illustrated embodiment as oriented in FIG. 2, alignment members 18a, 18b, 18e, and 18f will exert stiffness towards being flexed in a vertical direction relative to the base 16 while alignment members 18c, 18d, 18g, and 18h will exert stiffness towards being flexed in a horizontal direction relative to the base 16. While the alignment members 18a-18h have been described herein to be displaceable via a flexing motion, those having ordinary skill in the art will recognize other means in which to adjust the position of the alignment members 18a-18h. For instance, it is contemplated that the alignment members 18a-18h may be hinged to the base 16 such that displacement may also occur via a swinging motion, in addition to, or independent of, the above described flexing motion.

As further shown in FIG. 2, the retaining mechanism 12 may be coupled to a carrier 48, which includes a carrier associated with any of the aforementioned automobile lighting systems. In the illustrated embodiment, the retaining mechanism 12 is secured to the carrier 48 via mechanical fasteners 50. Additionally, or alternatively, the retaining mechanism 12 may be secured to the carrier 48 via adhesive, welding, or other suitable bonding methods. Further, the retaining mechanism 12 is operably coupled to the illumination source 15, which is disposed in the space 42 of the retaining mechanism 12. The illumination source 15 may include one or more light emitting diodes (LEDs) or other types of lighting. In the illustrated embodiment, the illumination source 15 is exemplarily shown as an array of light emitting diodes (LEDs), which may be directly connected to the carrier 48, or an intermediate substrate 52 such as a printed circuit board (PCB), heat sink, or other surface having heat dissipating properties. Alternatively, the base 16 of the retaining mechanism 12 can be constructed from metal and without space 42, thereby providing heat dissipation and enabling the illumination source 15 to be directly mounted thereto.

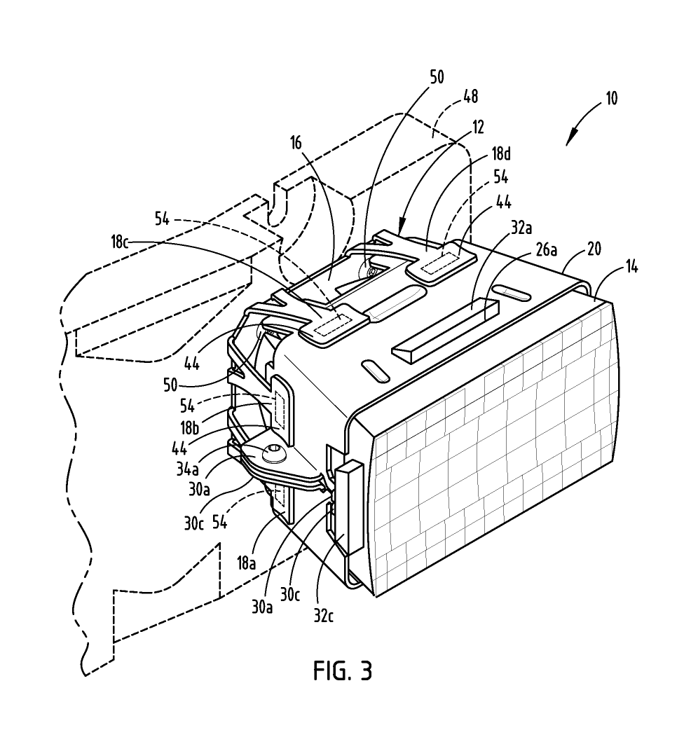

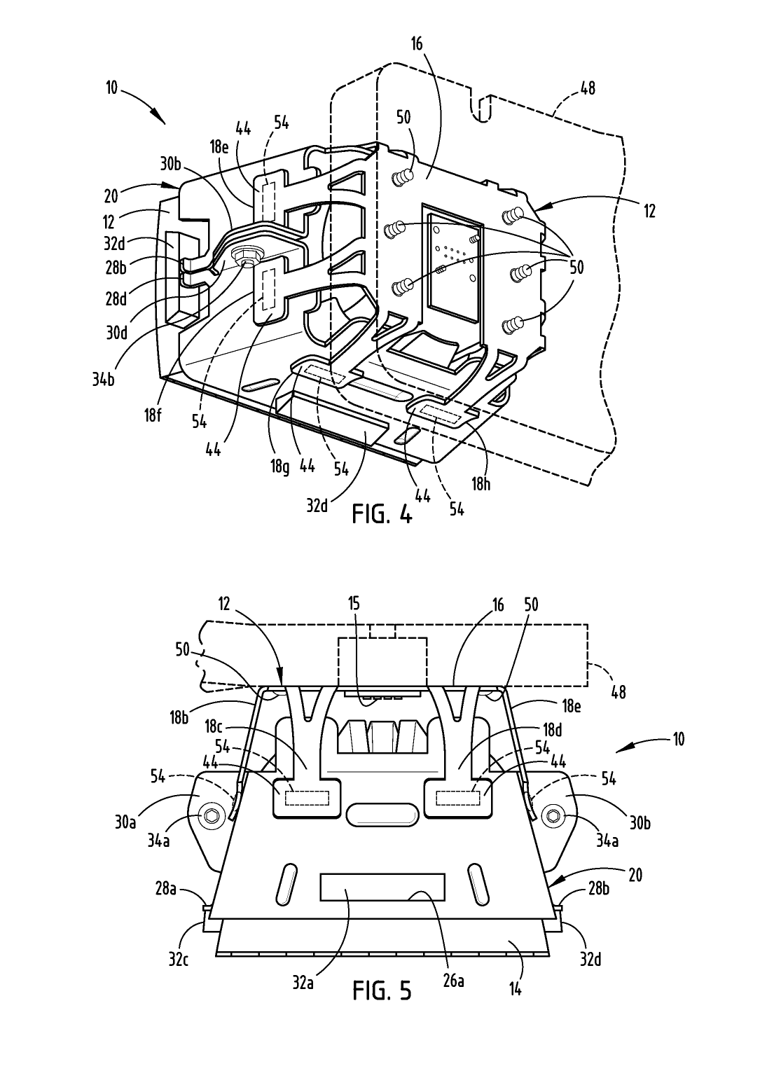

Referring to FIGS. 3-5, the retaining mechanism 12 and optical lens 14 of the previous embodiment are shown, wherein the retaining mechanism 12 is coupled to the carrier 48 and retains the optical lens 14 proximate to the illumination source 15. While, the optical lens 14 can be retained in a variety of positions, it is often desirable to retain the optical lens 14 in a position that optimizes light output therefrom, which typically occurs when the focal point of the optical lens 14 is aligned with the illumination source 15. In previous systems, attempts at positioning an optical lens relative to an illumination source often led to tolerance stack up, thus impacting the precision and efficiency of the beam pattern being emitted from the optical lens. These concerns can be substantially minimized through the adoption of the optical lens positioning system 10 described herein. As such, an optical lens positioning method adapted for use with the optical lens positioning system 10 is described below.

The optical lens positioning method includes placing the optical lens 14 in the retaining mechanism 12 such that the optical lens 14 is positioned between the alignment members 18a-18h. In the illustrated embodiment, the perimeter size of the lens holder 20 is configured to be larger than the entry point between the alignment members 18a-18h. Thus, as the lens holder 20 clears the entry point, the connecting portion 44 of each alignment member 18a-18h abuts against the lens holder 20 and the alignment members 18a-18h are flexed according to their respective planes of displacement in an outwards direction relative to the base 16 in order to accommodate the lens holder 20. This causes the alignment members 18a-18h to exert a force against the lens holder 20 since the alignment members 18a-18h have a natural disposition to return to their original positions when flexed in their respective planes of displacement.

When placed in the retaining mechanism 12, the position of the optical lens 14 can be adjusted by moving the optical lens 14 towards or away from the base 16 of the retaining mechanism 12. Due to the tapered configuration of the lens holder 20, when the optical lens 14 is moved towards the base 16, the shift in position causes the connecting portion 44 of each alignment member 18a-18h to abut against a larger perimeter portion of the lens holder 20. As a result, the alignment members 18a-18h will experience greater outward flex according to their respective planes of displacement in order to accommodate the lens holder 20. Conversely, when the optical lens 14 is moved away from the base 16, the shift in position causes the connecting portion 44 of each alignment member 18a-18h to abut against a smaller perimeter portion of the lens holder 20. As a result, the alignment members 18a-18h will naturally flex inwards relative to the base 16 toward their original position.

In addition to moving the optical lens 14 towards or away from the base 16, the position of the optical lens 14 within the retaining mechanism 12, as oriented in FIG. 3, may also be adjusted via sideways movement, upwards or downwards movement, horizontal rotation, and/or vertical rotation. In each of these cases, the alignment members 18a-18h will flex according to their planes of displacement in either an inward or outward direction relative to the base 16 in response to positional and/or rotational shifting of the optical lens 14. In this manner, the optical lens 14 can be easily positioned to obtain optimal light output, or other levels of light output, by simply observing the light output from the optical lens 14 while one or more of the aforementioned adjustments are being made. Thus, in view of the above-mentioned ways for adjusting the position of the optical lens 14, it should be evident that the retaining mechanism 12 of the illustrated embodiment is able to support movement of the optical lens 14 in up to three planes and rotation of the optical lens 14 about a maximum of two axes. As a result, the optical lens 14 may be positioned relative to the illumination source 15 at numerous distances that produce varying levels of light output from the optical lens 14. In addition, the optical lens 14 can be positioned orthogonally or at an angle with respect to the base 16 to enable light being outputted from the optical lens 14 to be aimed in a variety of directions.

Once the optical lens 14 is located in a desired position, the connecting portion 44 of each alignment member 18a-18h is fixedly coupled to the lens holder 20 so that the optical lens 14 is retained in a fixed position and is prevented from being further moved or rotated. In the illustrated embodiment, the connecting portions 44 are curved to increase surface area and welded to the lens holder 20 at weld points 54. Depending on the position and/or degree of rotation of the optical lens 14, the weld points 54 may be located on the connecting portions 44 at other positions. While the connecting portions 44 are shown welded to the lens holder 20, other bonding methods may be used additionally or alternatively, and include the use of adhesives and/or mechanical fasteners (e.g. bolts, screws, etc.). Furthermore, while the optical lens positioning method has been described in relation to the optical lens 14 and lens holder 20 ensemble, it is equally applicable to the optical lens 14 as a stand alone unit. For instance, in the event where no lens holder 20 is used, the optical lens 14 may be configured similarly to the lens holder 20 such that the alignment members 18a-18h abut directly against the optical lens 14 via their respective connecting portions 44 and flex accordingly, thus enabling the optical lens 14 to be positioned and rotated in the absence of the lens holder 20 in the manner previously described.

Accordingly, an optical lens positioning system and method has been advantageously provided herein, which enables an optical lens to be positioned proximate an illumination source and retained in a variety of positions. By employing the optical lens positioning system and method, the optical lens is easily positioned to obtain maximum optical performance, which minimizes tolerance stack up while increasing efficiency and precision for any given lumen budget.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

What is claimed is:

1. An optical lens positioning system comprising:
an illumination source;
an optical lens; and
a retaining mechanism having a plurality of alignment members that are displaceable in a first plane and resist being displaced in a second plane that is orthogonal to the first plane, wherein the plurality of alignment members are coupled to the optical lens to retain the optical lens proximate to the illumination source.

2. The optical lens positioning system of claim 1, wherein the illumination source is a light emitting diode (LED) array.

3. The optical lens positioning system of claim 1, wherein the optical lens is a collimating lens.

4. The optical lens positioning system of claim 1, wherein the optical lens is housed in a lens holder.

5. The optical lens positioning system of claim 1, wherein the retaining mechanism further comprises a base and the plurality of alignment members are coupled to the base and configured to extend therefrom.

6. The optical lens positioning system of claim 5, wherein the base comprises an intermediate portion connected to a first linear portion and a second linear portion to form a space therebetween.

7. The optical lens positioning system of claim 6, wherein the illumination source is provided in the space of the base.

8. The optical lens positioning system of claim 5, wherein the plurality of alignment members each comprise a bipedal portion cantilevered to the base and a connecting portion fixedly coupled to a periphery of the optical lens.

9. The optical lens positioning system of claim 7, wherein the plurality of alignment members are displaceable in the first plane via a flexing motion and exert stiffness towards being displaced in the second plane that is orthogonal to the first plane.

10. An optical lens positioning system comprising:
a retaining mechanism operably coupled to an illumination source and having a first and a second alignment member displaceable in nonplanar planes; and
an optical lens disposed between the first and second alignment members, wherein the first and second alignment members are configured to retain the optical lens in a fixed position proximate the illumination source.

11. The optical lens positioning system of claim 10, wherein the first alignment member is displaceable in a first plane and resists being displaced in a second plane that is orthogonal to the first plane.

12. The optical lens positioning system of claim 11, wherein the second alignment member is displaceable in a third plane and resists being displaced in a fourth plane that is orthogonal to the third plane.

13. The optical lens positioning system of claim 12, wherein the first alignment member is flexible in the first plane and exerts stiffness towards being flexed in the second plane that is orthogonal to the first plane, and the second alignment member is flexible in the third plane and exerts stiffness towards being flexed in the fourth plane that is orthogonal to the third plane.

14. The optical lens positioning system of claim 13, wherein the first plane is orthogonal to the third plane.

15. The optical lens positioning system of claim 10, wherein the retaining mechanism further comprises a base and the first and second alignment members are coupled to the base and configured to extend therefrom.

16. The optical lens positioning system of claim 15, wherein the first and second alignment members each comprise a bipedal portion cantilevered to the base and a curved connecting portion fixedly coupled to a periphery of the optical lens.

17. The optical lens positioning system of claim 16, wherein the base comprises an intermediate portion connected to a first linear portion and a second linear portion to form a space therebetween.

18. An optical lens positioning method comprising the steps of:
providing a retaining mechanism having a plurality of alignment members;
abutting the plurality of alignment members against a periphery of an optical lens;
adjusting the position of the optical lens, which causes the plurality of alignment members to be displaced; and
using the plurality of alignment members to retain the optical lens in a fixed position proximate an illumination source.

19. The optical lens positioning method of claim 18, wherein the step of adjusting the position of the optical lens further comprises aligning the focal point of the optical lens with the illumination source.

20. The optical lens positioning method of claim 18, wherein the step of adjusting the position of the optical lens further comprises moving the optical lens in up to three planes and rotating the optical lens about a maximum of two axes.
